(19) United States
(12) Patent Application Publication
(10) Pub. No.: US 2023/0382239 A1
(43) Pub. Date: Nov. 30, 2023

(54) Electric Bicycle System

(71) Applicants: Chia-Yu Lo, Taichung City (TW); Kuang-Yang Liao, Taichung City (TW)

(72) Inventors: Chia-Yu Lo, Taichung City (TW); Kuang-Yang Liao, Taichung City (TW)

(21) Appl. No.: 18/320,333

(22) Filed: May 19, 2023

(30) Foreign Application Priority Data
May 30, 2022 (TW) 111120256
Sep. 6, 2022 (TW) 111133876

(51) Int. Cl. B60L 15/20; B60L 50/20; B62M 6/55; B60L 53/00; B62J 50/22; A63B 22/06; A63B 24/00; A63B 21/00; A63B 21/005

(52) U.S. Cl. CPC B60L 15/20; B60L 50/20; B62M 6/55; B60L 53/00; B62J 50/22; A63B 22/0605; A63B 24/0087; A63B 21/00181; A63B 21/0057; A63B 21/0056; B60L 2200/12; B60L 2250/16

(57) ABSTRACT

This invention reveals an electric bicycle system including an electric bicycle and a docking device. When the electric bicycle is uprightly prop against the docking device, the electric bicycle can be driven with a pedal, making the electric bicycle system a training equipment.

### FIELD OF INVENTION

The present invention relates generally to a bicycle system, and particularly to an electric bicycle system.

### BACKGROUND OF THE INVENTION

Individuals who place great importance on leading a healthy lifestyle frequently opt for bicycles that possess the qualities of being convenient, low in pollutants, and suitable for exercise and leisure activities as a means of transportation or recreational pursuit. To enhance commuting ease and avoid issues such as fatigue or physical exhaustion while cycling, electric bicycles have emerged as a highly sought-after alternative.

However, electric bicycles often remain idle in garages or indoor spaces for most of the time when they are not being ridden. This not only occupies a significant amount of space but also hinders electric bicycles from realizing their full potential. Considering this, the development of technology that enhances the usability of electric bicycles when they are not being used for transportation has become an important goal to be fulfilled in the respective industry.

### SUMMARY OF THE INVENTION

Therefore, it is a primary objective of the present invention to provide an electric bicycle system to enhance the usability of an electric bicycle. The present invention discloses an electric bicycle system comprising an electric bicycle, wherein the electric bicycle comprises a motor, a resistance generating unit, and a control center, wherein: the control center is able to switch the electric bicycle to either a riding mode or a resistance mode, wherein in the resistance mode, the resistance generating unit provides multiple levels of resistance to a rear wheel of the electric bicycle; the motor connects to a battery, and the motor generates assisting force to propel the electric bicycle forward; and the resistance generating unit comprises a resistance controlling center, wherein the resistance controlling center controls movements of a clutch, controls the status of multiple resistance generators, and controls an electrical energy output by an output controlling center to tune multiple levels of the resistance, wherein: the clutch engages with the rear wheel of the electric bicycle in the resistance mode and creates a first level of the resistance, and the clutch disengages from the rear wheel in the riding mode, wherein the clutch is connected to an accelerator, and the accelerator increases the rotational speed of a coil winding in the resistance generator; the resistance generator connects to the clutch and comprises the coil winding, wherein the coil winding generates electrical energy during rotation; and the output controlling center regulates output values of voltage and/or current to modify the load output and generates adjustable multiple levels of the resistance and stores the electrical energy into the battery.

Wherein, the clutch connects to the accelerator, and the accelerator comprises a hub gear mounted on a hub of the electric bicycle and a resistance gear mounted on the resistance generator, wherein the hub gear and the resistance gear are arranged to engage with each other directly or indirectly, and the number of teeth of the hub gear is greater than that of the resistance gear.

Wherein, the accelerator comprises at least one planetary gearset.

Wherein, the electric bicycle comprises an operating unit, wherein the operating unit is a human-machine interface in a form of buttons, controllers, touch display panels, or mobile devices, and the operating unit receives inputs from a user, generates multiple commands, and sends the commands to the control center wirelessly or wired to tune multiple levels of the resistance.

Wherein, the resistance generating unit comprises a resistance device; and the output controlling center adjust the resistance of the resistance device based on the electrical energy produced by the resistance generator.

Wherein, the resistance generating unit automatically activates a maximum resistance mode and turn on all the resistance generators when the electric bicycle is parked outdoors or when the distance between the resistance generating unit and the operating unit exceeds a value, wherein in the maximum resistance mode all the resistance generators are turned on or the output load is set to maximum.

The electric bicycle system in accordance to this invention further comprising a docking device, wherein: the docking device securely and detachably attach to at least a rear axle or a frame of the electric bicycle, wherein the rear wheel of the electric bicycle can still rotate freely while pedaling; and the docking device further comprises a central controlling center, wherein the central controlling center connects to the control center, and the central controlling center stores multiple exercise courses; and the central controlling center receives the commands related to the exercise courses from the control center and executes the exercise courses accordingly.

Wherein, the electric bicycle is in the resistance mode when the electric bicycle is attached to the docking device or the exercise course is executing, and the central controlling center sends the commands to the control center and adjusts parameters of the resistance generating unit based on predefined parameters of the simulation conditions associated with the exercise course or parameters specified by an instructor of the exercise course.

Wherein, the docking device further comprises a sensing unit, wherein the sensing unit detects whether the electric bicycle is corrected mounted onto the docking device, and the sensing unit is a switch valve located on a part of the docking device where the electric bicycle is mounted or the sensing unit is a wireless connectivity feature between the central controlling center and the control center.

Wherein, the docking device further generates riding resistance for the electric bicycle using magnetic or contact mechanism, wherein multiple powerful magnets or generators are positioned on both sides of the rear wheel of the electric bicycle and further provides various levels of the resistance.

The present invention also discloses an electric bicycle system comprising an electric bicycle, wherein the electric bicycle comprises a motor, a resistance generating unit, and a control center, wherein: the control center is able to switch the electric bicycle to either a riding mode or a resistance mode, wherein: in the resistance mode, the resistance generating unit provides multiple levels of resistance to a rear wheel of the electric bicycle; and in the riding mode, the motor generates assisting force to propel the electric bicycle forward.

### BRIEF DESCRIPTION OF THE DRAWINGS

FIG. 1 is a schematic diagram of a preferred embodiment of an electric bicycle system in accordance with this invention;

FIG. 2 is a block diagram of a preferred embodiment of an electric bicycle system in accordance with this invention;

FIG. 3 is a block diagram of a preferred embodiment of an electric bicycle system in accordance with this invention;

FIG. 4 is a schematic diagram of a preferred embodiment of an electric bicycle system in accordance with this invention;

FIG. 5 is a schematic diagram of a preferred embodiment of an electric bicycle system in accordance with this invention;

FIG. 6 is a schematic diagram of a preferred embodiment of an electric bicycle system in accordance with this invention;

FIG. 7 is a schematic diagram of a preferred embodiment of an electric bicycle system in accordance with this invention;

FIG. 8 is a schematic diagram of a preferred embodiment of resistance generating unit in accordance with this invention; and

FIG. 9 is a schematic diagram of a preferred embodiment of resistance generating unit in accordance with this invention.

### DETAILED DESCRIPTION OF THE PREFERRED EMBODIMENTS

In order to make purposes, technical solutions, and advantages of the present invention to be clearer, the following content provides some preferred embodiments in accordance with the present invention.

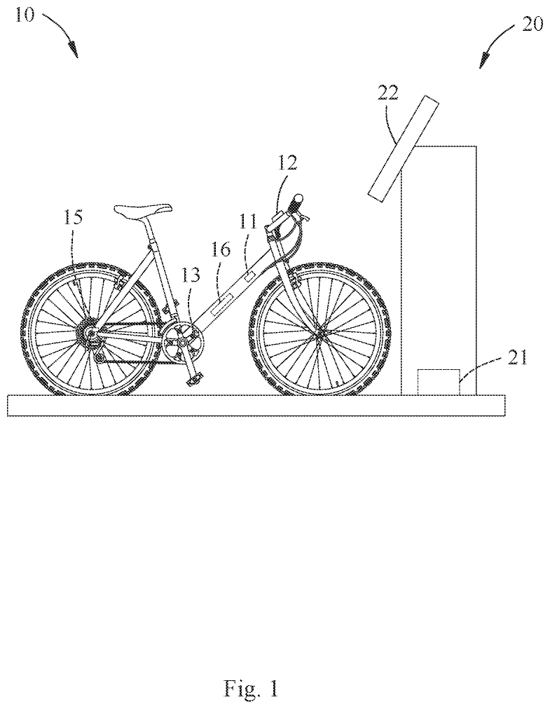

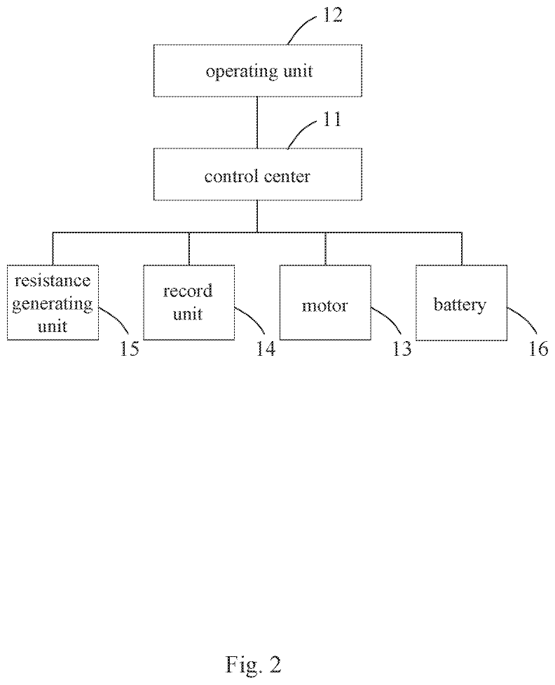

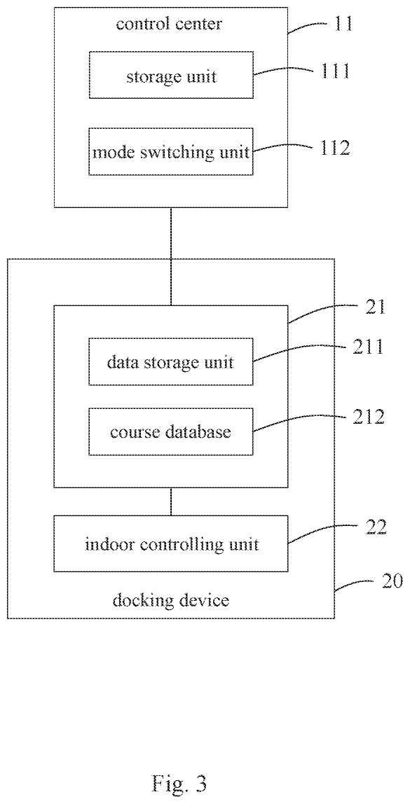

With reference to FIG. 1 to FIG. 3, a preferred embodiment of an electric bicycle system in accordance of this invention comprises an electric bicycle 10 and a docking device 20 for parking the electric bicycle 10. When the electric bicycle 10 is parked in the docking device 20, the electric bicycle 10 and the docking device 20 is electrically connected, and the electric bicycle 10 and the docking device 20 can exchange messages mutually. When the electric bicycle 10 is connected with the docking device 20, the electric bicycle system can be used as a fitness device, allowing the electric bicycle 10 to have various practical features when it is not used as a transportation vehicle.

The term “electrically connected” can be either a wired or wireless connection. The term “mutual message exchange” refers to the exchange of data or commands between the docking device 20 and the electric bicycle 10. Said data include but not limited to travel history, route, power status, calories, rider's data, resistance status, motor rotation data, and said commands include but not limited to output control of resistance and input/output of power to the electric bicycle 10. The method of exchanging data and commands between the docking device 20 and the electric bicycle 10 will be described in detail in subsequent paragraphs.

The electric bicycle 10 includes a control center 11, an operating unit 12, a motor 13, a recording unit 14, a resistance generating unit 15, and a battery 16. The control center 11 is electrically connected to the operating unit 12, the motor 13, the record unit 14, the resistance generating unit 15, and the battery 16. The operating unit 12 receives the command in the form of a user operation. The operating unit 12 can take various forms, such as a button, a controller, a touch display panel, a mobile device, or any other human-machine interface (HMI) that can display information and send commands, and the operating unit 12 can input commands or output display results. Preferably, the operating unit 12 is located in the area adjacent to the handlebars of the electric bicycle 10, making it easy for the user to operate while in the riding position.

The control center 11 is used to receive signals or commands from the docking device 20, the operating unit 12, the motor 13, the record unit 14, the resistance generating unit 15, and the battery 16 of the electric bicycle 10. The control center 11 also generates corresponding responses and output controls accordingly. For example, the control center 11 can drive the motor 13 to provide assistance to a rider and propel the electric bicycle 10 forward.

The signal received by the control center 11 can include information such as the remaining power and health status of the battery 16, abnormal messages generated by the motor 13, or the recorded data collected by the record unit 14. The control center 11 can then provide feedback to the operating unit 12 based on the received signals or directly provide feedback to the user.

The commands can come from either the operating unit 12 or the docking device 20. For instance, during a ride, the user can adjust the operating unit 12 according to their needs and send the commands to the control center 11 to activate the motor 13 to adjust the speed and assist output power of the electric bicycle 10 accordingly.

The control center 11 can further connect to a terminal device of a user via wireless network transmission technology and synchronously transmit the the signals or the commands to the terminal device.

Preferably, the control center 11 can utilize GNSS signals, such as GPS signals, and through network transmission to achieve real-time monitoring. For example, the control center 11 can be a controller with a universal communication protocol for bicycles, such as a motor controller that follows the CANBUS, FTMS, or CSCS protocols. The control center 11 can be a controller with a universal communication protocol for bicycles, such as a motor controller that follows the CANBUS, FTMS, or CSCS protocols. The controller communicates with the operating unit 12, the battery 16, and the motor 13 through the protocol(s), either wirelessly or wired.

The control center 11 reads the signals from the operating unit 12, obtains the power status signal from the battery 16, and adjusts the rotation output of the motor 13 based on the multiple signals received. Furthermore, the control center 11 can be connected to the terminal device of the user wirelessly, and synchronously transmit the signals or instructions to the terminal device.

In a preferred embodiment, the control center 11 includes a storage unit 111 and a mode switching unit 112. The storage unit 111 stores several records generated by the record unit 14. The record unit 14 collects and records the performance data of the electric bicycle 10 during riding, and form the records to be transmitted to the control center 11. For example, the path and distance traveled during riding, or the elevation when passing through a slope. The record unit 14 can also generate the records based on the user's pedaling or electrically driving performance on the electric bicycle 10 for the user's reference. Furthermore, the record unit 14 can be integrated into the terminal device (such as a mobile phone, wristband, etc.) and transmit signals to the control center 11 through wireless means.

The mode switching unit 112 of the control center 11 includes a riding mode and a resistance mode. The user can give instructions to the mode switching unit 112 via the operating unit 12 or external devices such as mobile devices to switch between the riding mode and resistance mode of the electric bicycle 10 according to their needs.

When the electric bicycle 10 is in the riding mode, the user can use it as a common electric bicycle. The motor 13 can output corresponding auxiliary rotation output based on the sensed output of the user's pedaling force, such as the torque sensor or the cadence sensor.

When the electric bicycle 10 switches to the resistance mode, the control center 11 activates the resistance generating unit 15 to establish an electrical connection with the battery 16. As the resistance generating unit 15 is activated, the resistance generating unit 15 converts mechanical energy generated from pedaling and the rotation of gears and tires into electrical energy, and the electrical energy is then returned to the battery 16. This allows the user 10 to charge the battery 16 while pedaling, making the electric bicycle 10 of this invention an energy-efficient and environmentally-friendly option.

Furthermore, in the resistance mode, the control center 11 of the electric bicycle 10 can choose to disable the electrical transmission loop between the battery 13 and the motor 13 to avoid unnecessary power consumption during charging. This also prevents the user from accidentally activating the motor 13 through the operating unit 12 during the resistance mode.

Moreover, the control center 11 can automatically switch between the riding mode and the resistance mode. For example, when the user starts the motor 13 with the operating unit 12, the control center 11 can automatically switch to the riding mode and turn off the resistance generating unit 15. When the user steps on the pedal, the control center 11 can automatically switch to the resistance mode and turn off the electric transmission circuit between the battery 13 and the motor 13; then, the control center 11 directly activates the resistance generating unit 15, making the resistance generating unit 15 instantly convert energy and charge the battery 16.

Similarly, the user can still decide whether the control center 11 should automatically switch between the riding mode and the resistance mode with the operating unit 12. This can prevent the control center 11 from repeatedly switching between the driving motor 13 and the resistance generating unit 15.

The resistance generating unit 15 is in the form of a generator. The generator can be a magnetic reluctance device, a contact friction device, or a combination of both. The resistance generating unit 15 provides rotational resistance to one of the wheels of the electric bicycle 10, and thus configured the electric bicycle 10 with multiple levels of resistance in the resistance mode to meet various pedaling force requirements. A preferred placement for the resistance generating unit 15 would be at the rear wheel of the electric bicycle 10. In this embodiment, the resistance generating unit 15 adjusts the output load of the multi-level riding resistance by regulating the voltage and/or current output, or by turning on/off multiple coil windings according to meet the demand for riding resistance. This enables the adjustment of multiple level outputs of riding resistance. The magnetic reluctance device of the resistance generating unit 15 can generate magnetic resistance on the wheel of the electric bicycle 10 by utilizing the interaction between magnets and eddy currents, and the resistance generating unit 15 can regulate the output voltage and/or current, or turn on/off multiple coil windings to adjust the generated magnetic resistance. The contact friction device of the resistance generating unit 15 directly provides different levels of rotational resistance to the rotating components of the electric bicycle 10, such as wheels and chainwheels, by direct contact.

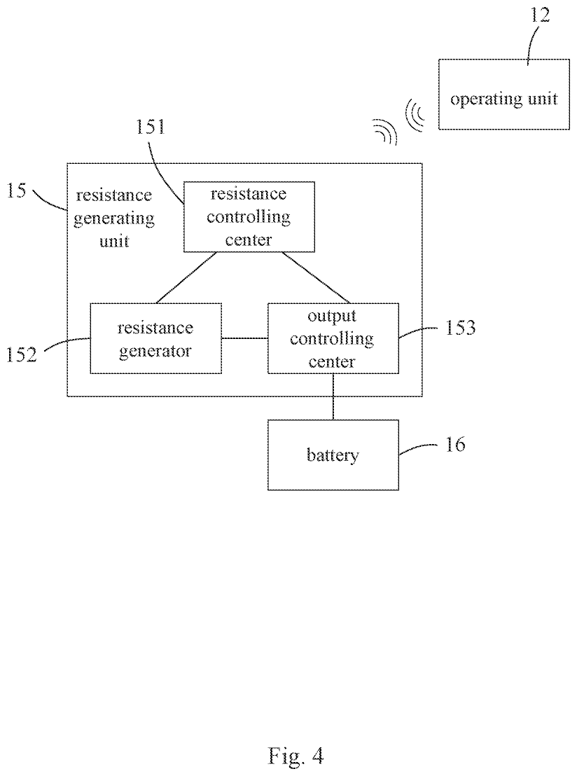

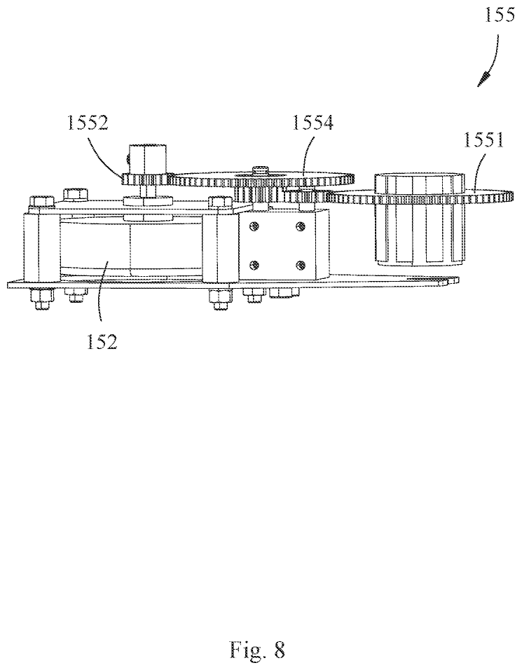

With reference to FIG. 4 to FIG. 8, the resistance generating unit 15 comprises a resistance controlling center 151, a resistance generator 152, and an output controlling center 153 that are electrically interconnected. The resistance controlling center 151 receives signals transmitted from the operating unit 12, determines whether the resistance generator 152 should be activated, and determines the amount of electrical energy to be outputted by the output controlling center 153 to the battery 16.

The resistance generator 152 in the present embodiment includes a coil winding. The resistance generator 152 produces the electrical energy by the rotation of the hub of the electric bicycle 10 relative to the coil winding and simultaneously generates rotational resistance (i.e., riding resistance) on the rear wheel of the electric bicycle 10. The resistance generator 152 is able to provide the electric bicycle 10 multiple levels of pedaling resistance in the resistance mode.

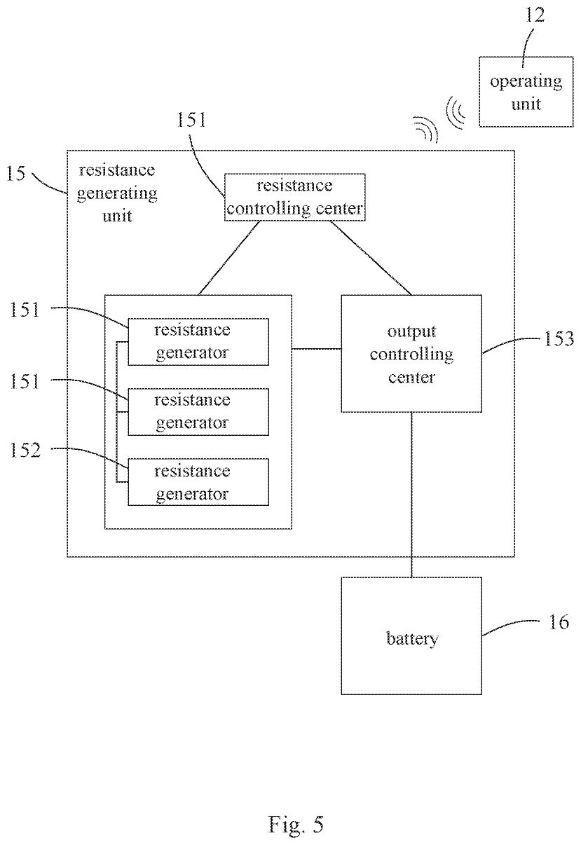

In a preferred embodiment in accordance with this invention as shown in FIG. 5, the resistance generating unit 15 includes several resistance generators 152, and the number of the resistance generators 152 to be turned on or turned off can be determined based on the level of resistance set in the resistance mode. The more resistance generators 152 that are turned on, the greater the rotational resistance and the greater the resistance applied to the flywheel, resulting in a greater riding resistance.

The output controlling center 153 is further used to regulate and set the output value of voltage and/or current. The output controlling center 153 can allocate the electrical energy generated by the resistance generator 152 and the energy output from the battery 16. The output controlling center 153 can also modify the output of electric load (i.e., output load) through voltage transformation and/or rectification, thereby adjusting the resistance levels during the rotation of the hub to achieve different levels of resistance.

By tuning the on and off of multiple resistance generators 152 or adjusting the output of the output controlling center 153, the electric bicycle 10 can possess variable resistance modes with multiple levels. This allows the electric bicycle 10 to offer various levels of resistance for different riding experiences.

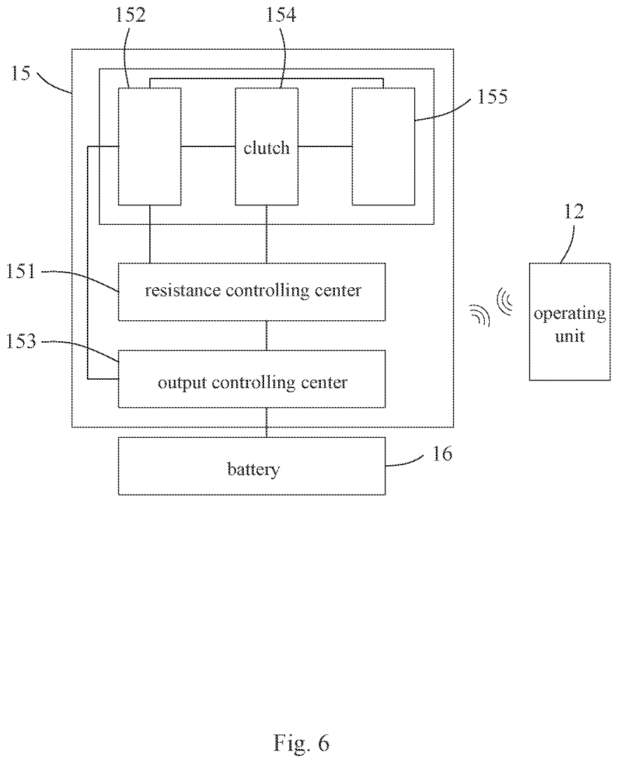

In a preferred embodiment, as shown in FIG. 6, the resistance generating unit 15 is positioned on the hub of the rear wheel of the electric bicycle 10, and the resistance generating unit 15 is detachably connected to the hub. Moreover, the resistance generating unit 15 is equipped with a clutch 154. The clutch 154 operates according to the mode specified by the resistance controlling center 151. In the assist mode, the clutch disengages from the electric bicycle 10 and disconnects the resistance generators 152 from the electric bicycle 10, reducing the resistance during riding and thus enhancing the riding experience. When the electric bicycle 10 switches to the resistance mode, the clutch 154 engages with the electric bicycle 10 and creates a first level of riding resistance.

In a preferred embodiment shown in FIG. 6, the resistance generating unit 15 includes an accelerator 155. The accelerator 155 is designed to increase the rotational speed of the coil winding in the resistance generator 152. Preferably, the accelerator 155 includes a hub gear 1551 mounted on the hub and a resistance gear 1552 mounted on the resistance generator 152, wherein the hub gear 1551 and the resistance gear 1552 are arranged to engage with each other directly or indirectly. By adjusting the gear ratio between the hub gear 1551 and the resistance gear 1552 (e.g., by having a much greater number of teeth on the hub gear 1551 compared to the resistance gear 1552), the overall rotational speed of the resistance generator 152 can be significantly greater than that of the hub gear 1551. In this preferred embodiment, an idler gear 1554 is provided between the hub gear and the resistance generator 152 to prevent any interference between the components. This idler gear 1554 ensures smooth and efficient transmission of rotational motion between the hub gear 1551 and the resistance generator 152.

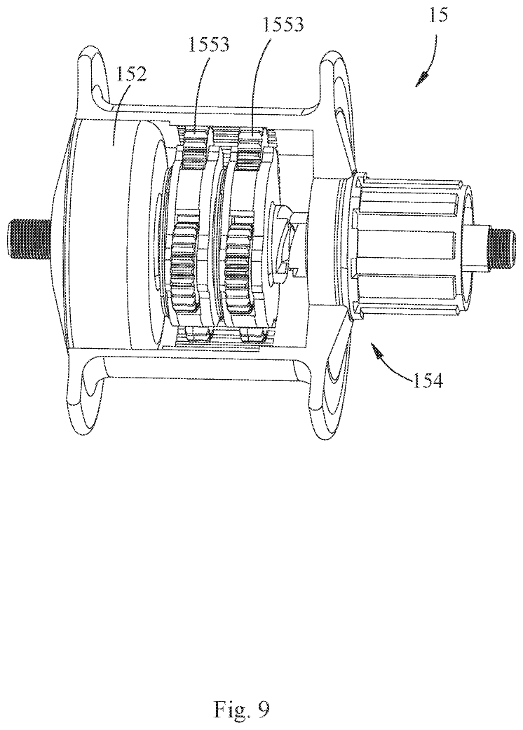

With reference to FIG. 9, a preferred embodiment of the resistance generating unit 15 is installed on the hub and the resistance generating unit 15 also includes the resistance generator 152, the clutch 154, and the accelerator 155. The accelerator 155 is positioned between the resistance generator 152 and the clutch 154. Preferably, the accelerator 155 includes at least one planetary gearset 1553. In a preferred configuration, the accelerator 155 consists of two parallel planetary gearsets 1553 positioned next to the resistance generator 152. In the resistance mode, the clutch 154 engages with the hub. The hub is driven by a chain of the electric bicycle 10, and the planetary gearset 1553 rotates in accordance with the rotation of the hub; thereby the planetary gearset 1553 drives the operation of the resistance generator 152 and greatly increase the rotation speed of the coil winding of the resistance generator 152. This configuration of the planetary gearset 1553 enables a significant reduction in overall size of the resistance generator 152 while achieving increased efficiency in generating resistance and generating electricity. In the riding mode, the clutch 154 disengages from the hub, reducing resistance during riding and enhancing the riding experience.

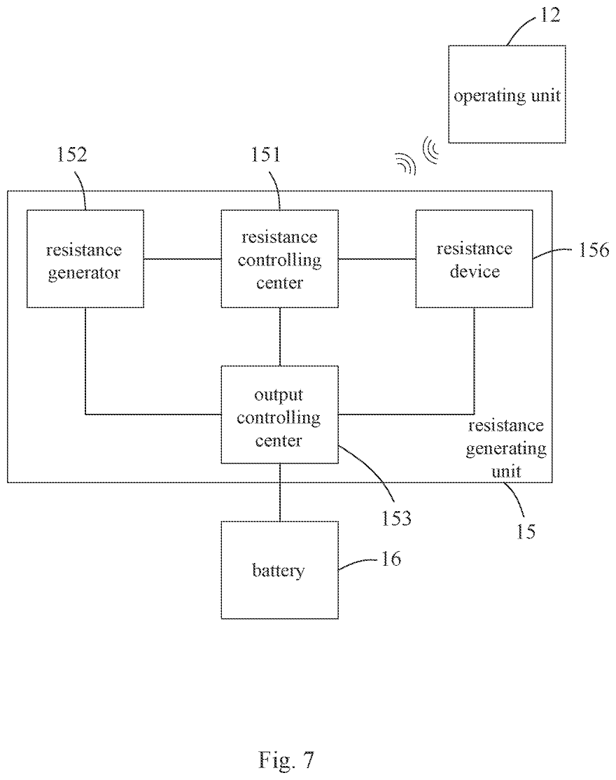

With reference to FIG. 7, in a preferred embodiment, the resistance generating unit 15 can also include a resistance device 156, which directly generates resistance to avoid insufficient resistance provided by the resistance generator 152, ensuring sufficient fitness functionality. The resistance controlling center 151 receives signals from the operating unit 12 and activates the resistance generator 152 based on the settings of the resistance mode. In this preferred embodiment, the output controlling center 153 can determine the activation and tuning of the resistance device 156 based on the resistance generated by the resistance generator 152. This ensures that the electric bicycle 10 can provide stable resistance in the resistance mode, regardless of the speed at which the rider pedals the electric bicycle 10 or the amount of energy generated by the resistance generator 152.

Furthermore, in another preferred embodiment, the resistance generating unit 15 serves as a braking assistance device. For example, during braking, the resistance generating unit 15 receives a brake signal from the electric bicycle 10. The resistance controlling center 151 determines the level of resistance to be generated by either the resistance generating unit 15 or the output controlling center 153 based on the brake signal.

The docking device 20 comprises a central controlling center 21 and an indoor controlling unit 22. The electric bicycle 10 can be securely mounted in an upright position on the docking device 20. When the electric bicycle 10 is mounted on the docking device 20, the pedals of the electric bicycle 10 can still be operated to engage the gears and move the wheels. This allows the electric bicycle 10 to be used as a fitness device indoors when not in use for riding. Thus, the electric bicycle system in accordance with this invention can be used regardless of weather conditions, environment, or space, making the electric bicycle 10 suitable for both outdoor and indoor settings. Ideally, when the electric bicycle 10 is placed on the docking device 20, the rear wheel of the electric bicycle 10 is either suspended or free to rotate, in order to prevent any movement of the electric bicycle 10 caused by pedaling.

The central controlling center 21 can be connected to the indoor controlling unit 22 and the control center 11 to receive the signals or the commands transmitted from the control center 11 and the indoor controlling unit 22. The central controlling center 21 then generates corresponding responses accordingly. The indoor controlling unit 22 can take various forms, such as buttons or touch panels. A preferable configuration for the indoor controlling unit 22 is to have it positioned as a panel in the handlebar area of the electric bicycle 10.

The central controlling center 21 includes a course database 212, which contains several exercise courses generated based on simulation conditions. The user can select an exercise course through the indoor controlling unit 22. The central controlling center 21 adjusts the settings of the resistance generating unit 15 of the electric bicycle 10 based on predefined parameters of the simulation conditions associated with the exercise course or parameters specified by an instructor of the exercise course. This adjustment can be done either by modifying the configuration parameters of the resistance generating unit 15 or by sending the commands to the control center 11.

For example, the central controlling center 21 can adjust the inclination angle of the electric bicycle 10 based on the simulation conditions of the exercise course. This adjustment can be done by sending commands to the control center 11 and adjusting the resistance generating unit 15 located near the pedal to increase the resistance on the pedal while pedaling and thus create a riding resistance that corresponds to the simulation conditions. This provides the user with a simulated uphill riding experience and increases the intensity of the exercise.

Furthermore, the user can also adjust the parameters of the exercise course according to preferences using the indoor controlling unit 22 or the operating unit 12. This allows for customization of the exercise course, tailoring the exercise course to the user's specific needs and goals.

The central controlling center 21 also includes a data storage unit 211. The data storage unit 211 is used to store the execution records and parameters of each exercise course. The execution records may include the duration of the exercise course, rest periods during the process, calories burned, the number of executions, and historical data.

Furthermore, the data storage unit 211 can also store the records from the electric bicycle 10. When the central controlling center 21 is connected to the control center 11, the user can transfer the records from the storage unit 111 to the data storage unit 211 by operating the indoor controlling unit 22 or the operating unit 12. This enables the user to conveniently view the records directly through the docking device 20 or the indoor controlling unit 22.

Furthermore, the central controlling center 21 can store data in the data storage unit 211 in a cloud server through internet connection. This allows the user to connect through the terminal device and access the data in the data storage unit 211.

Furthermore, the docking device 20 can further include the resistance generating unit 15. When the electric bicycle 10 is being used as a flywheel device, the resistance generating unit 15 can convert the kinetic energy generated by pedaling into electrical energy. This energy can then be charged back into the battery 16, thus providing the electric bicycle system with self-generation capabilities.

Furthermore, the docking device 20 includes a sensing unit to determine whether the electric bicycle 10 is positioned near the docking device 20 or mounted on the docking device 20 correctly. The sensing unit can be a switch valve located on the docking device 20 where the electric bicycle 10 is mounted, the sensing unit can also be a wireless connectivity feature between the central controlling center 21 and the control center 11. In a preferred embodiment, the sensing unit can be a mechanical latch or an optical sensor used to detect whether the electric bicycle 10 is correctly mounted on the docking device 20.

In one embodiment, the sensing unit is the switch valve. Once the electric bicycle 10 is mounted on the docking device 20, the switch valve is activated; the central controlling center 21 directly or indirectly establishes an electrical connection between the electric bicycle 10 and the docking device 20.

In another embodiment, the sensing unit is a wireless connectivity feature between the central controlling center 21 and the control center 11. When the electric bicycle 10 is in proximity to the docking device 20, the central controlling center 21 or the control center 11 can establish a connection with the sensing unit via wireless transmission protocols such as Near Field Communication (NFC), Bluetooth, or other similar protocols. Once connected, the operating unit 12 or the indoor controlling unit 22 can provide, for example, an option to charge the battery 16 of the electric bicycle 10.

Furthermore, when the exercise course is executed, the central controlling center 21 or the control center 11 can also choose to activate the resistance mode and initiate the resistance generating unit 15. Therefore, the electric bicycle system of this invention can simultaneously charge the battery 16 through the resistance generating unit 15 while the exercise course is executed.

The central controlling center 21 can thus to the control center 11, enabling the user to select or adjust the appropriate exercise courses. With the data storage unit 211 and network connectivity, the user can directly access the data through the docking device 20 or the terminal device.

Furthermore, the docking device 20 can retrieve the record from the record 14, display the record, and assist the user in achieving daily training goals.

Moreover, to enhance the stability of the connection between the docking device 20 and the electric bicycle 10, the docking device 20 is designed to securely attach to at least the rear axle or frame of the electric bicycle 10. This allows the rear wheel of the electric bicycle 10 to rotate freely while pedaling.

The docking device 20 can also generate riding resistance for the electric bicycle 10 using magnetic or contact mechanism. For example, multiple powerful magnets or generators can be positioned on both sides of the rear wheel of the electric bicycle 10. By moving closer to or farther away from the rear wheel of the electric bicycle 10, the docking device 20 can adjust the riding resistance according to different resistance requirements. This provides the electric bicycle 10 with a wider range of resistance options in the resistance mode, allowing the user to choose from various levels of riding resistance.

Furthermore, the resistance generating unit 15 can automatically activate a maximum resistance mode when the electric bicycle 10 is parked outdoors or when there is the distance between the resistance generating unit 15 and the operating unit 12 exceeds a value. The maximum resistance mode can be achieved by turn on the coil winding of all the resistance generators 152 or adjusting the output load to its maximum setting. This increases the resistance level and prevents the electric bicycle 10 from being stolen. Moreover, the resistance generating unit 15 communicates with the operating unit 12 and/or the control center 11 using a common communication protocol such as CANBUS, BLE, ANT+, etc. This allows the control center 11, the operating unit 12, the user's mobile device, or the docking device 20 to seamlessly control the resistance generating unit 15 and adjust the resistance level as needed.

1. An electric bicycle system comprising an electric bicycle, wherein the electric bicycle comprises a motor, a resistance generating unit, and a control center, wherein:
the control center is able to switch the electric bicycle to either a riding mode or a resistance mode, wherein in the resistance mode, the resistance generating unit provides multiple levels of resistance to a rear wheel of the electric bicycle;
the motor connects to a battery, and the motor generates assisting force to propel the electric bicycle forward; and
the resistance generating unit comprises a resistance controlling center, wherein the resistance controlling center controls movements of a clutch, controls the status of multiple resistance generators, and controls an electrical energy output by an output controlling center to tune multiple levels of the resistance, wherein:
the clutch engages with the rear wheel of the electric bicycle in the resistance mode and creates a first level of the resistance, and the clutch disengages from the rear wheel in the riding mode, wherein the clutch is connected to an accelerator, and the accelerator increases the rotational speed of a coil winding in the resistance generator;
the resistance generator connects to the clutch and comprises the coil winding, wherein the coil winding generates electrical energy during rotation; and
the output controlling center regulates output values of voltage and/or current to modify the load output and generates adjustable multiple levels of the resistance and stores the electrical energy into the battery.

2. The electric bicycle system according to claim 1, wherein the clutch connects to the accelerator, and the accelerator comprises a hub gear mounted on a hub of the electric bicycle and a resistance gear mounted on the resistance generator, wherein the hub gear and the resistance gear are arranged to engage with each other directly or indirectly, and the number of teeth of the hub gear is greater than that of the resistance gear.

3. The electric bicycle system according to claim 1, wherein the accelerator comprises at least one planetary gearset.

4. The electric bicycle system according to claim 1, wherein the electric bicycle comprises an operating unit, wherein the operating unit is a human-machine interface in a form of buttons, controllers, touch display panels, or mobile devices, and the operating unit receives inputs from a user, generates multiple commands, and sends the commands to the control center wirelessly or wired to tune multiple levels of the resistance.

5. The electric bicycle system according to claim 2, wherein the electric bicycle comprises an operating unit, wherein the operating unit is a human-machine interface in a form of buttons, controllers, touch display panels, or mobile devices, and the operating unit receives inputs from a user, generates multiple commands, and sends the commands to the control center wirelessly or wired to tune multiple levels of the resistance.

6. The electric bicycle system according to claim 3, wherein the electric bicycle comprises an operating unit, wherein the operating unit is a human-machine interface in a form of buttons, controllers, touch display panels, or mobile devices, and the operating unit receives inputs from a user, generates multiple commands, and sends the commands to the control center wirelessly or wired to tune multiple levels of the resistance.

7. The electric bicycle system according to claim 6, wherein:
the resistance generating unit comprises a resistance device; and
the output controlling center adjust the resistance of the resistance device based on the electrical energy produced by the resistance generator.

8. The electric bicycle system according to claim 1, wherein the resistance generating unit automatically activates a maximum resistance mode and turn on all the resistance generators when the electric bicycle is parked outdoors or when the distance between the resistance generating unit and the operating unit exceeds a value, wherein in the maximum resistance mode all the resistance generators are turned on or the output load is set to maximum.

9. The electric bicycle system according to claim 4, wherein the resistance generating unit automatically activates a maximum resistance mode and turn on all the resistance generators when the electric bicycle is parked outdoors or when the distance between the resistance generating unit and the operating unit exceeds a value, wherein in the maximum resistance mode all the resistance generators are turned on or the output load is set to maximum.

10. The electric bicycle system according to claim 7, wherein the resistance generating unit automatically activates a maximum resistance mode and turn on all the resistance generators when the electric bicycle is parked outdoors or when the distance between the resistance generating unit and the operating unit exceeds a value, wherein in the maximum resistance mode all the resistance generators are turned on or the output load is set to maximum.

11. The electric bicycle system according to claim 1 further comprising a docking device, wherein:
the docking device securely and detachably attach to at least a rear axle or a frame of the electric bicycle, wherein the rear wheel of the electric bicycle can still rotate freely while pedaling; and
the docking device further comprises a central controlling center, wherein the central controlling center connects to the control center, and the central controlling center stores multiple exercise courses; and the central controlling center receives the commands related to the exercise courses from the control center and executes the exercise courses accordingly.

12. The electric bicycle system according to claim 4 further comprising a docking device, wherein:
the docking device securely and detachably attach to at least a rear axle or a frame of the electric bicycle, wherein the rear wheel of the electric bicycle can still rotate freely while pedaling; and
the docking device further comprises a central controlling center, wherein the central controlling center connects to the control center, and the central controlling center stores multiple exercise courses; and the central controlling center receives the commands related to the exercise courses from the control center and executes the exercise courses accordingly.

13. The electric bicycle system according to claim 10 further comprising a docking device, wherein:
the docking device securely and detachably attach to at least a rear axle or a frame of the electric bicycle, wherein the rear wheel of the electric bicycle can still rotate freely while pedaling; and
the docking device further comprises a central controlling center, wherein the central controlling center connects to the control center, and the central controlling center stores multiple exercise courses; and the central controlling center receives the commands related to the exercise courses from the control center and executes the exercise courses accordingly.

14. The electric bicycle system according to claim 11, wherein the electric bicycle is in the resistance mode when the electric bicycle is attached to the docking device or the exercise course is executing, and the central controlling center sends the commands to the control center and adjusts parameters of the resistance generating unit based on predefined parameters of the simulation conditions associated with the exercise course or parameters specified by an instructor of the exercise course.

15. The electric bicycle system according to claim 11, wherein the docking device further comprises a sensing unit, wherein the sensing unit detects whether the electric bicycle is corrected mounted onto the docking device, and the sensing unit is a switch valve located on a part of the docking device where the electric bicycle is mounted or the sensing unit is a wireless connectivity feature between the central controlling center and the control center.

16. The electric bicycle system according to claim 14, wherein the docking device further comprises a sensing unit, wherein the sensing unit detects whether the electric bicycle is corrected mounted onto the docking device, and the sensing unit is a switch valve located on a part of the docking device where the electric bicycle is mounted or the sensing unit is a wireless connectivity feature between the central controlling center and the control center.

17. The electric bicycle system according to claim 11, wherein the docking device further generates riding resistance for the electric bicycle using magnetic or contact mechanism, wherein multiple powerful magnets or generators are positioned on both sides of the rear wheel of the electric bicycle and further provides various levels of the resistance.

18. The electric bicycle system according to claim 13, wherein the docking device further generates riding resistance for the electric bicycle using magnetic or contact mechanism, wherein multiple powerful magnets or generators are positioned on both sides of the rear wheel of the electric bicycle and further provides various levels of the resistance.

19. The electric bicycle system according to claim 15, wherein the docking device further generates riding resistance for the electric bicycle using magnetic or contact mechanism, wherein multiple powerful magnets or generators are positioned on both sides of the rear wheel of the electric bicycle and further provides various levels of the resistance.

20. An electric bicycle system comprising an electric bicycle, wherein the electric bicycle comprises a motor, a resistance generating unit, and a control center, wherein:
the control center is able to switch the electric bicycle to either a ridding mode or a resistance mode, wherein:
in the resistance mode, the resistance generating unit provides multiple levels of resistance to a rear wheel of the electric bicycle; and
in the ridding mode, the motor generates assisting force to propel the electric bicycle forward.
